(19) United States
(12) Patent Application Publication
(10) Pub. No.: US 2025/0159089 A1
(43) Pub. Date: May 15, 2025

(54) IMAGE FORMING SYSTEM AND PRINTING METHOD

(71) Applicant: KONICA MINOLTA, INC., Tokyo (JP)

(72) Inventor: Mitsunori NAKAMURA, Tokyo (JP)

(73) Assignee: KONICA MINOLTA, INC., Tokyo (JP)

(21) Appl. No.: 18/901,232

(22) Filed: Sep. 30, 2024

(30) Foreign Application Priority Data
Nov. 9, 2023 (JP) 2023-191344

(51) Int. Cl. H04N 1/00; G03G 15/00

(52) U.S. Cl. CPC H04N 1/00822; G03G 15/6588; H04N 1/00724; H04N 1/00734; G03G 2215/00489

(57) ABSTRACT

An image forming system includes: a reader including a reading sensor that optically reads a sheet conveyed through a conveyance path; and a hardware processor that controls the reader, in which the reader is able to execute a plurality of reading modes including at least a first reading mode and a second reading mode different from the first reading mode, and reads the sheet in any one of the reading modes selected according to a print setting, and the hardware processor varies an image formation timing of forming an image on the sheet by an image former between when switching of the reading modes is performed and when the switching of the reading modes is not performed.

### CROSS-REFERENCE TO RELATED APPLICATION

The entire disclosure of Japanese patent application No. 2023-191344, filed on Nov. 9, 2023, is incorporated herein by reference in its entirety.

### BACKGROUND OF THE INVENTION

### 1. Technical Field

The present invention relates to an image forming system and a printing method.

### 2. Description of Related Art

In an image forming apparatus, there is a technique for detecting the size of a sheet and correcting an image in accordance with the detected size (for example, Patent Literature 1 (Japanese Unexamined Patent Application Publication No. 2014-238544)). In the image forming apparatus disclosed in Patent Literature 1, a size measuring section is disposed at a position sufficiently upstream of an image former, so that the correction for image position set based on the measurement result of the size measuring section is reflected on the detected sheet.

Furthermore, in Patent Literature 1, a contact image sensor (CIS) that measures a sheet width as a size measuring section detects positions of side ends of a sheet (the position of a right end and the position of a left end in a conveyance direction). Thus, the sheet width is measured (paragraph 0013).

### SUMMARY OF THE INVENTION

There are various types of sheet used in the image forming apparatus, and for example, dark-colored sheet other than white sheet may be used. When a colored sheet is used, the above-described image forming apparatus that detects the positions of both side ends of the sheet by the CIS may not accurately detect the positions of side ends of the colored sheet due to insufficient contrast at the positions of the ends.

The present invention has been made in view of the above circumstances, and an object thereof is to accurately detect a sheet size or a sheet shape at an appropriate timing.

To achieve at least one of the abovementioned objects, according to an aspect of the present invention, a device reflecting one aspect of the present inventions comprises the followings.

An image forming system including:
a sheet feeder that feeds a sheet;
a conveyor that conveys the sheet through a conveyance path;
a reader including a reading sensor that optically reads the sheet conveyed through the conveyance path;
an image former that forms an image on the conveyed sheet at a downstream side of the reader in the conveyance path; and
a hardware processor, wherein the reader is able to execute a plurality of reading modes including at least a first reading mode and a second reading mode different from the first reading mode, and reads the sheet in any one of the reading modes selected according to a print setting, and
the hardware processor varies an image formation timing of forming an image on the sheet by the image former between when switching of the reading modes is performed and when the switching of the reading modes is not performed.

### BRIEF DESCRIPTION OF THE DRAWINGS

The advantages and features provided by one or more embodiments of the present invention will be more fully understood from the following detailed description and the accompanying drawings. However, these are for purposes of illustration only and are not intended to limit the present invention.

FIG. 1 is a diagram illustrating a schematic configuration of an image forming apparatus including a reading device according to the present embodiment;

FIG. 2 is a block diagram illustrating a hardware configuration of an image forming system;

FIGS. 3A and 3B are schematic diagrams illustrating the main configuration of a reader according to a first embodiment;

FIG. 4 is a schematic diagram illustrating a main configuration of the reader;

FIG. 5 is a table for describing use conditions of surfaces of a background section;

FIG. 6 is a table for describing use conditions of surfaces of the background section;

FIG. 7 is a flowchart illustrating processing of switching a background surface and printing processing in the first embodiment;

FIG. 8 is a subroutine flowchart illustrating the processing of step S120 in FIG. 7;

FIGS. 9A and 9B illustrate an example of a print job;

FIG. 10 is an example of a table illustrating a switching time required for switching from a reading mode for the previous sheet to a reading mode for the next sheet;

FIG. 11 is a table for describing use conditions of surfaces of a background section according to a second embodiment;

FIG. 12 is a table for describing use conditions of surfaces of a background section according to the second embodiment; and

FIG. 13 is a subroutine flowchart illustrating processing in step S120 in FIG. 7 according to the second embodiment.

### DETAILED DESCRIPTION

Embodiments of the present invention will be described hereinafter with reference to the accompanying drawings. It is to be noted that the scope of the present invention is not limited to the embodiments to be described. Note that in the description of the drawings, the same components are denoted by the same reference signs, and redundant descriptions will not be repeated. In addition, dimensional ratios in the drawings are exaggerated for convenience of description and may be different from actual ratios. In the drawings, a top-bottom direction (vertical direction) is defined as a Z direction, a front direction and a rear direction of an image forming system or a reading device are defined as a Y direction, and a direction orthogonal to the Y and Z directions is defined as an X direction. The X direction is also referred to as a conveyance direction of a sheet. The Y direction is also referred to as a width direction. In the present embodiment, the sheet includes a printing sheet (hereinafter simply referred to as sheet) and various films.

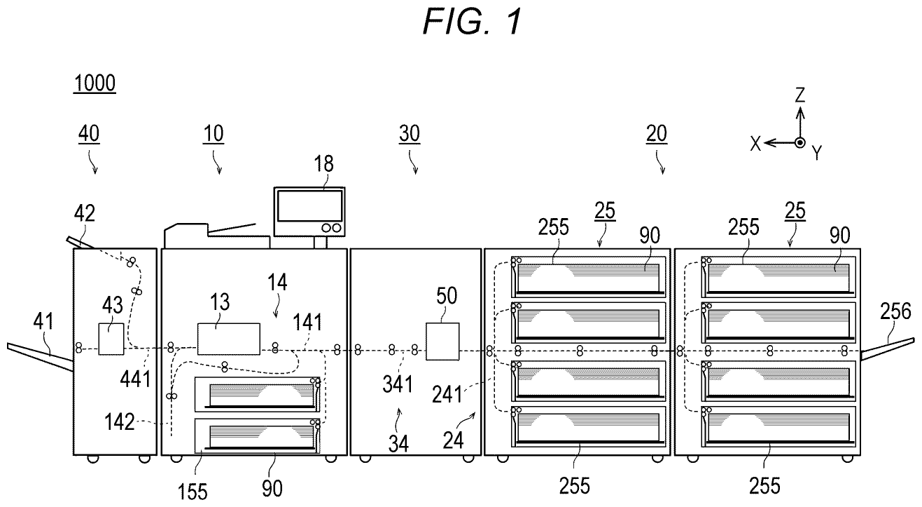

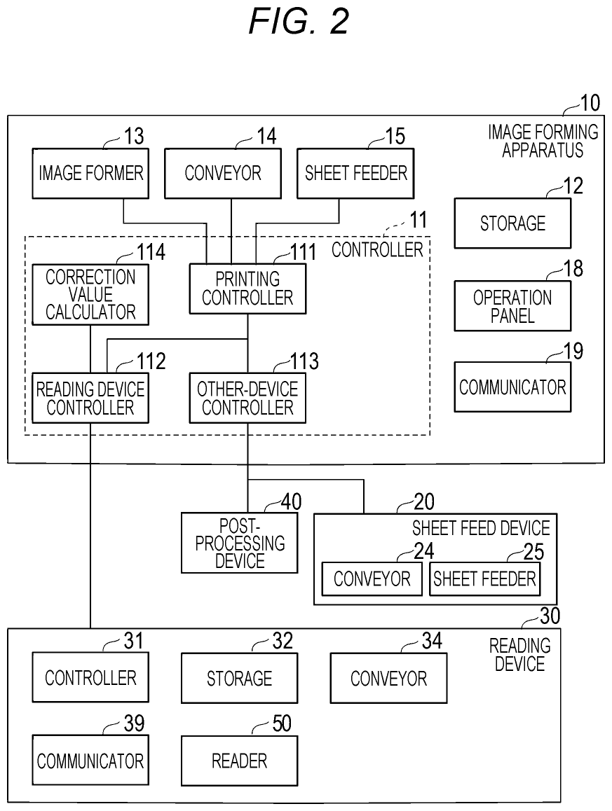

FIG. 1 is a diagram illustrating a schematic configuration of an image forming system 1000 including a reading device 30 according to the present embodiment. FIG. 2 is a block diagram illustrating a hardware configuration of the image forming system 1000. As illustrated in FIG. 1, the image forming system 1000 includes an image forming apparatus 10, a sheet feed device 20, a reading device 30, and a post-processing device 40, which are mechanically and electrically connected to each other.

### (Image Forming Apparatus 10)

The image forming apparatus 10 forms an image on a sheet 90 fed from the sheet feed device 20 on the upstream side and sent via the reading device 30. Further, the image forming apparatus 10 forms an image on a sheet 90 fed from a sheet feeder of the image forming apparatus 10.

The image forming apparatus 10 includes a controller 11 (hardware processor), a storage 12, an image former 13, a conveyor 14, a sheet feeder 15, an operation panel 18, a communicator 19, and the like. These components are connected to each other via a signal line such as a bus for exchanging signals. Note that in FIG. 2, connection signal lines to some constituent elements such as the storage 12 and the operation panel 18 in the image forming apparatus 10 are not illustrated (connection to a controller 31 or the like of the reading device 30 to be described later is similarly not illustrated).

### (Controller 11)

The controller 11 includes a CPU, a ROM, a RAM, and the like. The controller 11 executes various kinds of processing by executing programs stored in the ROM and the storage 12 described later, and controls components of the apparatus and executes various kinds of calculation processing in accordance with the programs. The controller 11 functions as a printing controller 111, a reading device controller 112, an other-device controller 113, and a correction value calculator 114. The functions of these sub-controllers 111 to 114 will be described later.

### (Storage 12)

The storage 12 includes an auxiliary storage such as a hard disk that stores various kinds of programs and various kinds of data. Further, the storage 12 stores sheet information regarding the sheets stored in each of sheet feed trays (trays 155, 255, 256, etc. to be described below) in association with the corresponding tray. The sheet information includes information regarding the brand, size (sheet width, sheet length), color, basis weight (weight), and type (gloss coated paper, matt coated paper, plain paper, high-quality paper, rough paper, etc.) of the sheet. In addition, the storage 12 may store a sheet brand, a determination model (determination model algorithm) used for determining a control parameter, and a paper profile. Furthermore, the storage 12 stores a switching time required for switching the background section 56, a sheet interval time (sheet interval) associated with switching of the sheet feed tray (sheet feed tray 255, 256, or the like to be described later), and a sheet interval time (sheet interval) for each sheet size. Here, the sheet interval time is an interval (the unit is a conveyance time) from the trailing end of the preceding sheet 90 to the leading end of the next sheet 90. In addition, conditions for executing stabilization processing performed by the image former 13 are set in the storage 12. For example, the stabilization processing is executed at a timing when a predetermined event such as power-on of the main body occurs or every predetermined number of printed sheets (for example, every 1000 sheets).

### (Image Former 13)

The image former 13 forms an image by, for example, an electrophotographic method. The image former 13 includes writing sections (laser exposure sections) and photosensitive drums respectively corresponding to basic colors of yellow (Y), magenta (M), cyan (C), and black (K), and developing devices each accommodating a two-component developer including toner of the corresponding color and a carrier. The image former 13 further includes an intermediate transfer belt, a secondary transferer, and a fixer. Toner images formed on the photosensitive drums by the developing devices of the respective colors are superimposed on the intermediate transfer belt, and are transferred onto the conveyed sheet 90 at the secondary transferer. The toner image on the sheet 90 is fixed on the sheet 90 by being heated and pressed by the fixer on a downstream side.

The image former 13 is provided with a density sensor that optically detects the density of a toner patch formed on the intermediate transfer belt. In the stabilization processing, multiple patch images that vary in color and gradation (density) are printed on the intermediate transfer belt on the basis of evaluation chart data stored in the storage 12. The reflection densities of the patch images are detected by the density sensor, and the image forming conditions are adjusted based on the obtained data.

### (Conveyor 14, Sheet Feeder 15)

The conveyor 14 includes conveyance paths 141, 142, and the like. The sheet feeder 15 includes a plurality of sheet feed trays 155. The conveyance path 141 includes a plurality of conveyance roller pairs provided along the conveyance path and a drive motor (not illustrated) that drives the conveyance roller pairs. The sheet feeder 15 includes a delivery roller that delivers an uppermost sheet of a plurality of sheets 90 loaded and placed in the sheet feed tray 155, and delivers the sheets 90 in the sheet feed tray to a conveyance path on the downstream side one by one. A conveyance path 341 of the reading device 30 is connected to the upstream side of the conveyance path 141.

The conveyor 14 conveys the sheet 90 fed from the sheet feed tray 155 and the like. The sheet 90 conveyed on the conveyance path 141 is subjected to image formation by the image former 13, and then ejected onto a sheet ejection tray 41 via the subsequent post-processing device 40. In double-sided printing in which an image is also formed on a back surface (second surface) of the sheet 90, the sheet 90 on which an image has been formed on one side is conveyed to the conveyance path 142 for double-sided image formation in a lower portion of the apparatus body. The sheet 90 conveyed to the conveyance path 142 is turned over on a switchback path and then conveyed to the conveyance path 141 for single-sided printing, and an image is again formed on the other side of the sheet 90 by the image former 13.

### (Operation Panel 18, etc.)

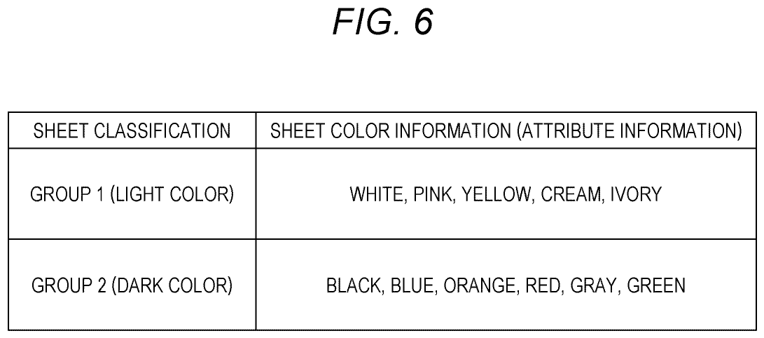

The operation panel 18 includes a touch screen, a numeric keypad, a start button, a stop button, and the like. The operation panel 18 displays a state of the image forming apparatus 10 or the image forming system 1000, and is used to input various settings and instructions from a user. The user can set, through a setting screen of the operation panel 18, information regarding the type and color of sheets loaded in the sheet feed trays 155, 255, and the like (see FIG. 6 described later). Furthermore, the user can make the following settings through the setting screen of the operation panel 18 or a setting screen of a print setting application that runs on a personal computer (PC) communicably connected to the image forming system 1000 (hereinafter, referred to as operation panel or the like).

The user can set, as a print setting,
(1) the size of sheet to be used,
(2) color information regarding the color of the sheet,
(3) enabled/disabled for sheet image correction position, and the like. Note that in the following, the sheet size and color information of the sheet are also referred to as attribute information of the sheet.

The communicator 19 is an interface for communicating with a PC or other devices 20, 30, or the like.

### (Sub-controllers 111 to 114)

When receiving a print job, the printing controller 111 executes the print job on the basis of print job setting information of the input print job. The print job is input in response to an instruction sent from the operation panel 18 or an external terminal such as a network-connected PC operated by the user.

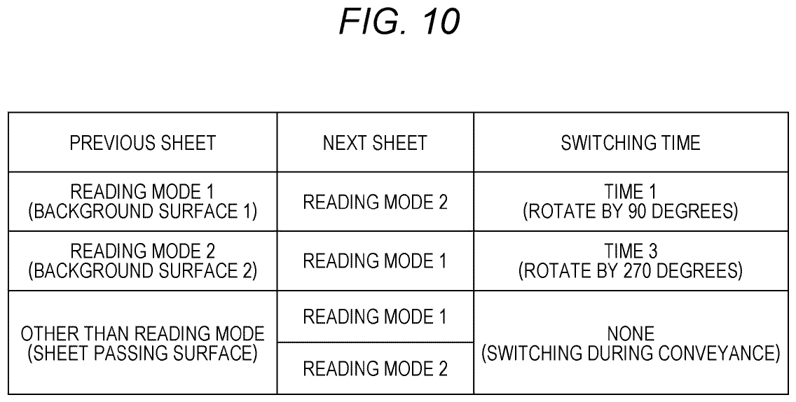

The printing controller 111 controls feeding and conveyance of the sheet 90 by controlling the conveyor 14 (including the conveyance paths 141 and 142 and the drive motors for the fixer, and the like) and the sheet feeder 15. Furthermore, the printing controller 111 instructs the reading device controller 112 to read the sheet 90 on which an image has not yet been formed (reading instruction) in accordance with the setting of the print job (setting of enabling image position correction). In addition, the printing controller 111 calculates a time (hereinafter, referred to as “switching time”) required for switching the background surface (refer to FIG. 4 which will be described later) between reading modes. The switching time may be calculated on the basis of the positional relationship between the current background surface (background surface 1, 2, or sheet passing surface) and the background surface to be switched (rotation amount such as 90 degrees or 270 degrees) and the movement speed (rotation speed). Further, a table which is stored in the storage 12 in advance and in which background surfaces for the previous and next sheets and switching time therefor are described may be referred to (e.g., see FIG. 10 described later). Alternatively, the switching time may be acquired by asking the controller 31 of the reading device 30 through the reading device controller 112.

Further, the printing controller 111 compares the switching time with the current sheet interval time. Then, when the switching time is longer than the sheet interval time, the printing controller 111 controls the image former 13 and/or the sheet feeder 255 and the like so as to delay the image formation timing or widen the sheet interval.

Further, the printing controller 111 controls the image former 13 to control the image formation timing and adjust vertical and horizontal magnifications according to image forming conditions and a sheet position based on a sheet position correction value calculated by a correction value calculator 114 to be described later. In the following, the control of the image formation timing with the sheet position correction value and the adjustment of the vertical and horizontal magnifications are referred to as position correction control.

As described below, the position correction control is performed on at least one of the first surface (front surface) and the second surface (back surface) according to at least the arrangement position of the reader 50. The arrangement conditions of the reader 50 vary depending on the conveyance path length or the conveyance speed of the reading device 30, or connection of another device between the reading device 30 and the image forming apparatus 10.

### (1) Arrangement Condition Possible for Both the First Surface and the Second Surface

For example, when the arrangement condition of the reader 50 is that the reader 50 is located sufficiently upstream of the image former 13 (as in, for example, Japanese Unexamined Patent Publication No. 2014-238544), and the image correction can be performed in time, the position correction control of the sheet 90 that has been read is performed.

Specifically, in a case where the reader 50 is disposed in a positional relationship in which (b) comes after (a) described below, the position correction control is performed when an image is formed on the first surface and/or the second surface of the sheet 90 that has been read: (a) a timing at which preparation for image formation reflecting the position correction control is completed from image data (hereinafter, referred to as read data) obtained by the reader 50 of the reading device 30 reading the sheet 90; and (b) a timing at which the image formation on the sheet 90 is started.

### (2) Arrangement Condition Possible for Only Second Surface

When the arrangement condition of the reading device 30 is that the reading device 30 is located at a position where the image correction cannot be performed in time, image formation reflecting the position correction control is performed at the time of image formation on the second surface (back surface) during double-sided image formation for the read sheet 90 in order to register images on the front and back surfaces.

The reading device controller 112 controls the reading device 30 in response to an execution instruction request (reading instruction) from the printing controller 111. In response to the execution instruction request, the reading device 30 causes the reader 50 and other various sensors included in the reading device 30 to measure the sheet characteristics. Furthermore, when the sheet 90 is read by the reading device 30, the reading device controller 112 acquires the read data generated by the reading device 30.

The other-device controller 113 controls the sheet feed device 20 and the post-processing device 40. Specifically, the other-device controller 113 communicates with the sheet feed device 20 to transmit and receive a sheet feed tray to be used, a sheet conveyance timing, and the like. Specifically, the other-device controller 113 transmits, to the post-processing device 40, a sheet conveyance timing, information regarding setting of post-processing for the sheet to be conveyed, and the like.

The correction value calculator 114 acquires the read data obtained by reading the sheet 90 on which an image has not yet been formed from the reading device controller 112, and detects the characteristics of the length of each of the sides (vertical and horizontal sides) or the shape of the sheet 90 from the acquired read data. Hereinafter, the detected characteristics are also simply referred to as “sheet size”. The correction value calculator 114 calculates an image position correction value from a difference between the detected sheet size and the sheet size in the print setting. The calculated image position correction value is sent to the printing controller 111. As described above, the printing controller 111 performs the position correction control according to the sheet position on the basis of the image position correction value.

### (Sheet Feed Device 20)

As illustrated in FIGS. 1 and 2, the sheet feed device 20 includes a conveyor 24 and a sheet feeder 25. In addition, the sheet feed device 20 includes a controller, a storage, and a communicator (none of which are illustrated) in addition to the conveyor 24 and the sheet feeder 25, and these components are connected to each other via a signal line such as a bus for exchanging signals.

The sheet feeder 25 includes a plurality of sheet feed trays 255 and a manual sheet feed tray 256. The sheet feed trays 255 are automatically numbered from tray 1 to tray n based on a predetermined rule. The conveyor 24 and the sheet feeder 25 have the same functions as those of the conveyor 14 and the sheet feeder 15, feed the sheets 90 placed on the sheet feed trays 255 or the like one by one, and convey the sheets 90 to the conveyance path 241. The conveyance path 241 is connected to the subsequent conveyance path 341. The sheet 90 fed from each of the sheet feed trays 245 and the like and conveyed on the conveyance path 241 is conveyed to the reading device 30 on the downstream side, and is subjected to the measurement of the sheet characteristics such as the sheet size or image formation by the image forming apparatus 10 on the further downstream side.

### (Post-processing Device 40)

The post-processing device 40 performs post-processing on the sheet 90 sent from the image forming apparatus 10 or ejects the sheet 90 according to the setting of the print job. The post-processing device 40 includes sheet ejection trays 41 and 42, a post-processor 43, and a conveyance path 441. In addition, the post-processing device 40 includes a controller, a storage, a conveyor, and a communicator (none of which are illustrated), and these components are connected to each other via a signal line such as a bus for exchanging signals. The sheet ejection trays 41 and 42 are selected in accordance with the setting of the print job. The conveyance path 441 is connected to the conveyance path 141 on the upstream side. The post-processor 43 performs at least one of stapling, punching, cutting, folding, or bookbinding on the sheet 90 on which an image has been formed.

### (Reading Device 30)

Next, the reading device 30 will be described. As illustrated in FIG. 2, the reading device 30 includes a controller 31, a storage 32, a conveyor 34, a communicator 39, the reader 50, and the like. The controller 31, the storage 32, the conveyor 34, and the communicator 39 have the same hardware configuration as the controller 11, the storage 12, the conveyor 14, and the communicator 19, respectively, of the image forming apparatus 10 described above, and thus the description thereof is omitted.

### (Reader 50)

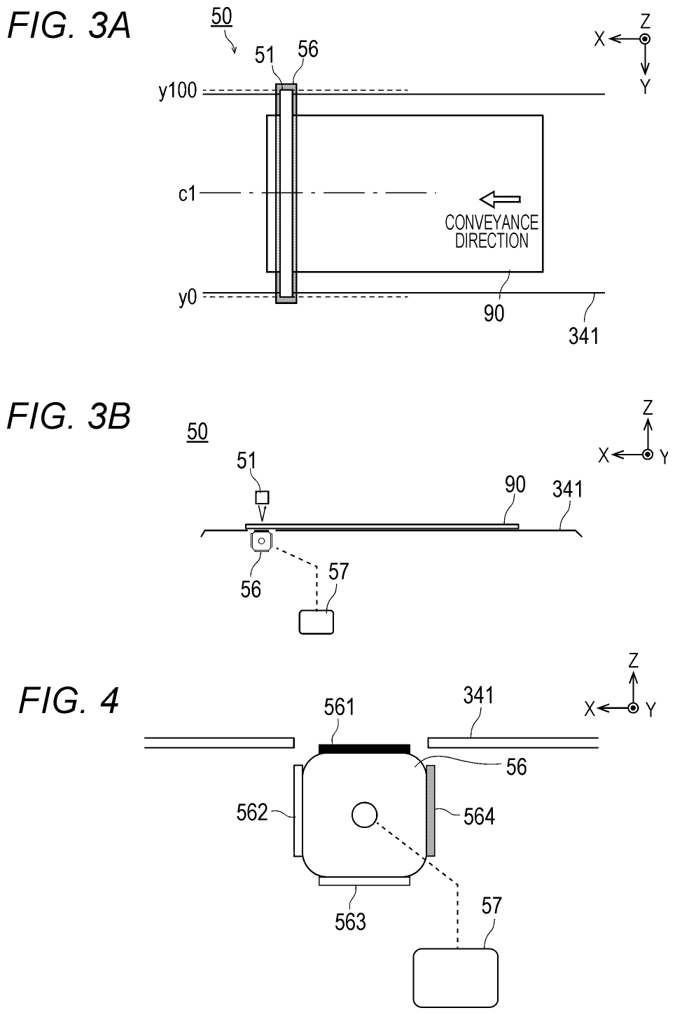

The outline of the reader 50 will be described below with reference to FIGS. 3 to 6. FIGS. 3 and 4 are schematic diagrams illustrating a main configuration of the reader 50. FIG. 3A is a top view and FIG. 3B is a side view. The reader 50 includes a reading sensor 51, a background section 56, and a switching mechanism 57. The reading sensor 51 is a one-dimensional line sensor including a plurality of photoelectric conversion elements arranged in the Y direction, and reads a one-dimensional image. The reading sensor 51 also includes optical elements such as light emitting elements or lens arrays arranged along the line of the photoelectric conversion elements. During reading, the light emitting elements emit light that is uniform in an extending direction of the line toward the sheet 90 on the conveyance path 341. The reader 50 reads the sheet 90, whereby read data corresponding to one sheet is generated.

The background section 56 has a prismatic shape having a polygonal cross section and an axis extending in the Y direction. In the example illustrated in FIG. 4 and the like, the background section 56 has a quadrangular prism shape having four surfaces 561 to 564. The switching mechanism 57 includes a rotation mechanism such as a drive source and a gear, and switches the background surface facing the reading sensor 51 by controlling the rotation position of the background section 56. For example, the switching mechanism 57 including a servo motor or a stepping motor rotates the background section 56 in the clockwise direction in FIG. 4 around the rotation axis by a predetermined angle (an integral multiple of 90 degrees) and stops the background section 56 at that position.

As illustrated in FIGS. 3B and 4, the background section 56 is disposed to face the reading sensor 51 across the conveyance path 341. The background section 56 is placed in a cutout portion of a lower guide plate constituting the conveyance path 341. The surface facing the reading sensor 51 among the four surfaces 561 to 564 of the background section 56 is switched by the switching mechanism 57.

Note that the configuration of the background section 56 is not limited to the example illustrated in FIG. 4 and the like, and any other configuration may be employed. For example, four surfaces are arranged in the X direction on the background section 56 having a plate shape. Then, the surface facing the reading sensor 51 is switched by sliding forward or backward the background section 56 by a predetermined amount in the X direction by the switching mechanism 57. As another example, the background section 56 may be configured by a device, such as electronic paper, which can electronically switch the density of the display surface. In this case, the density (brightness) of the surface facing the reading sensor 51 is switched by electrical control.

As illustrated in FIG. 3A, a reading region of the reading sensor 51 ranges from y0 to y100 in the Y direction, and is wider than the width of the maximum sheet 90 that can be conveyed in the image forming system 1000. In addition, in the Y direction, a center cl of the conveyance of the sheet 90 and a center cl of the reading region of the reading sensor 51 are aligned with each other.

### (Background Surfaces 1 and 2, Sheet Passing Surface, etc.)

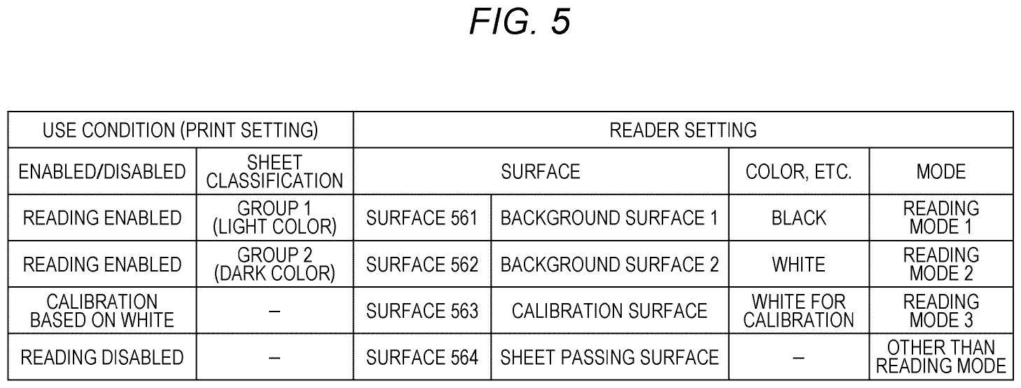

FIGS. 5 and 6 are tables for describing use conditions of the surfaces 561 to 564 of the background section 56. These tables are stored in advance in the storage 12 or the storage 32. Background surfaces 1 and 2 (surfaces 561 and 562) are surfaces used when the reading by the reader 50 is set as enabled. Hereinafter, reading using background surface 1 may be referred to as reading mode 1, and reading using background surface 2 may be referred to as reading mode 2. Here, one of reading modes 1 and 2 corresponds to a first reading mode, and the other corresponds to a second reading mode.

The surface 561 is black or has a color having brightness equal to or less than a predetermined value (for example, having L* of the CIELAB color space equal to or less than 20). The surface 561 is a first background surface (hereinafter, also referred to as “background surface 1”) serving as a background of the sheet 90 when the sheet 90 is read by the reading sensor 51. As illustrated in FIGS. 5 and 6, background surface 1 is used when the color information regarding the color of the sheet 90 to be read indicates a light color included in a first group and having a brightness difference from the surface 561 larger than a predetermined value.

The surface 562 is white or has a color having brightness equal to or more than a predetermined value (for example, having L* of the CIELAB color space equal to or less than 70). The surface 562 is a second background surface (hereinafter, also referred to as “background surface 2”) serving as a background of the sheet 90 when the sheet 90 is read by the reading sensor 51. As illustrated in FIGS. 5 and 6, background surface 2 is used when the color information regarding the color of the sheet 90 to be read indicates a dark color included in a second group and having a brightness difference from the surface 562 equal to or greater than a predetermined value.

The surface 563 is a calibration surface used for calibration of the reading sensor 51 periodically performed at a predetermined timing of the reading sensor 51. For example, the surface 563 is formed to have a white color in a defined range and is used for adjustment of white balance and a white level.

The surface 564 is used when reading is not performed (reading is set as disabled), and functions as a sheet passing surface that closes the cutout portion of the lower guide plate of the conveyance path 341 at the time of sheet passing.

### (Processing of Switching Background Surface and Printing Processing)

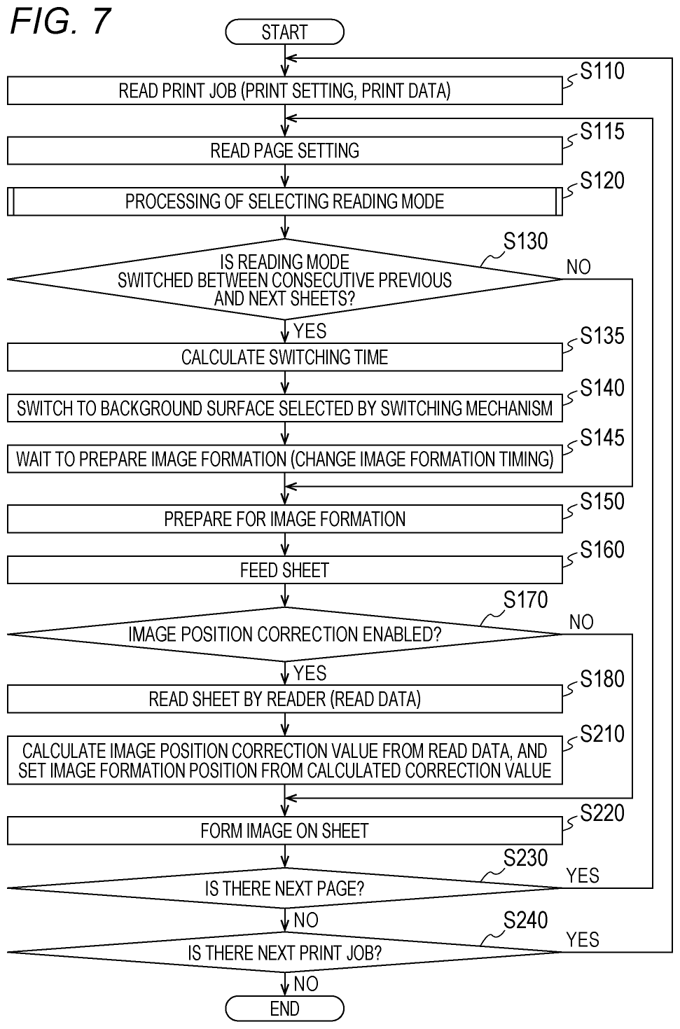

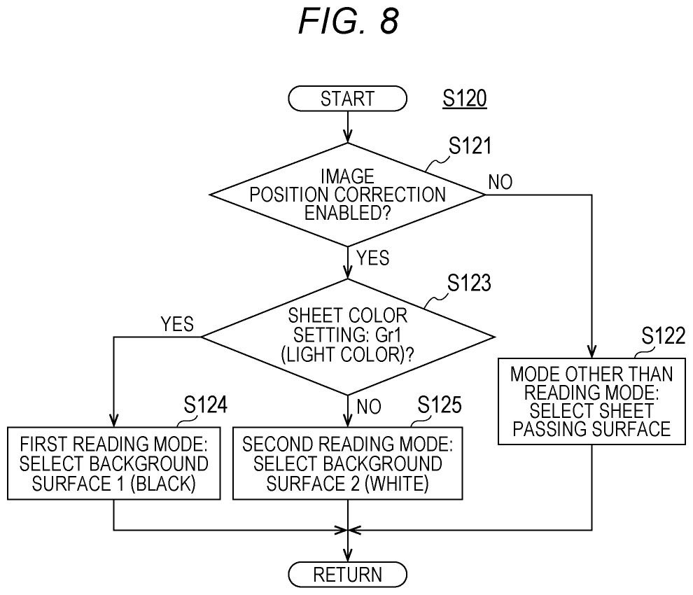

Next, control for image formation timing associated with processing for switching the background surface and printing processing that are executed in the image forming system 1000 according to the first embodiment will be described with reference to FIGS. 7 and 8.

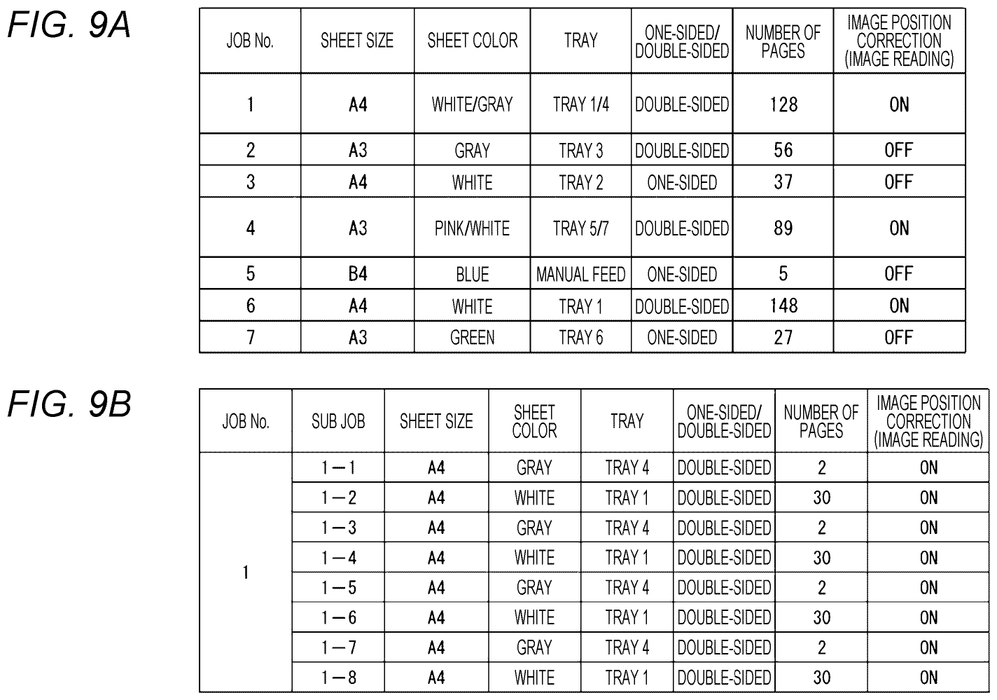

FIG. 7 is a flowchart illustrating processing of switching the background surface executed by the reading device 30 and printing processing executed by the image forming system 1000. FIG. 8 is a subroutine flowchart illustrating the processing of step S120 in FIG. 7. FIGS. 9A and 9B illustrate examples of print jobs to be executed. The table in FIG. 9A indicates a job list, and FIG. 9B is a table indicating detailed information of job 1 in the job list. The print jobs in the job list are consecutively performed in order from job 1. The image forming system 1000 consecutively conveys a plurality of sheets 90, consecutively executes image reading, and consecutively performs image formation (according to setting of image position correction) according to a print setting in each job.

### (Step S110)

The printing controller 111 of the controller 11 reads the first print job in a print job reservation list. In the example illustrated in FIG. 9A, the first job 1 is read. The print job includes a print setting and print data (document image data). As illustrated in FIG. 9A, the print setting includes at least sheet color (sheet attribute information) for each page and setting of whether to enable or disable image position correction for each print job or for each page.

### (Step S115)

The printing controller 111 acquires page setting from the print setting of the print job currently being executed.

### (Step S120)

The printing controller 111 performs processing of selecting a reading mode on the basis of the print setting or the page setting. This processing will be described with reference to the subroutine flowchart in FIG. 8.

### (Step S121)

The printing controller 111 determines whether or not the image position correction is enabled with reference to the print setting or the page setting. The printing controller 111 advances the processing to step S122 when the image position correction is set as disabled, and advances the processing to step S123 when it is set as enabled. In the example of job 1 in FIG. 9A, the image position correction is set as “enabled”.

### (Step S122)

The printing controller 111 selects a mode other than the reading mode. In this case, the sheet passing surface (surface 564) is selected.

### (Step S123)

The printing controller 111 acquires the sheet color (sheet information) in the print setting, and determines whether the sheet color belongs to group 1 (light color) or group 2 (dark color) with reference to the table in FIG. 6. The printing controller 111 advances the processing to step S124 when the sheet color belongs to group 1, and advances the processing to step S125 when it does not belong to group 1 (when it belongs to group 2).

### (Step S124)

The printing controller 111 selects reading mode 1. In this case, background surface 1 (black) (surface 561) is selected. For example, in the example of job 1 in FIG. 9B, the sheet color is white (group 1) from page 3 to page 33 in sub-job 1-2, and thus, background surface 1 (black) is selected.

### (Step S125)

The printing controller 111 selects reading mode 2. In this case, background surface 2 (white) (surface 562) is selected. For example, in the example of job 1 in FIG. 9B, the sheet color is gray (group 2) from page 34 to page 35 in sub-job 1-3. Therefore, background surface 2 (white) corresponding to reading mode 2 selected in response to the switching from the sheet feed tray 1 to the sheet feed tray 4 is selected. Thus, the printing controller 111 ends the processing in FIG. 8 and returns to processes in step S130 and subsequent steps in FIG. 7.

### (Step S130)

The printing controller 111 acquires setting information for the current reading mode (background surface) from the reading device controller 112. Then, the printing controller 111 determines whether or not the reading mode is to be switched due to the current reading mode being different from the reading mode selected in step S120. The printing controller 111 advances the processing to step S150 when the reading mode is the same between the consecutive previous and next sheets, and advances the processing to step S135 when the reading mode is to be switched.

### (Step S135)

The printing controller 111 calculates the switching time for switching the background surface between the reading modes. FIG. 10 is an example of a table illustrating the switching time required for switching from the reading mode for the previous sheet to the reading mode for the next sheet. The switching time from reading mode 1 to reading mode 2 is time 1 (e.g., 0.5 sec). The switching time from reading mode 2 to reading mode 1 is time 3 (for example, 1.0 sec) longer than time 1. In addition, in a case where the previous sheet is in a mode (sheet passing surface) other than the reading mode, switching to the reading mode for the next sheet can be performed while the sheet one or several sheets before is being conveyed or is passing through the reader 50 (in particular, the reading region), so that the switching time is substantially zero.

### (Step S140)

The printing controller 111 controls the switching mechanism 57 by the controller 31 through the reading device controller 112 to switch to the reading mode (background surface) selected in step S120. For example, when the mode other than the reading mode (sheet passing surface) is selected in step S122, the background surface is switched to the sheet passing surface, and when reading mode 1 (background surface 1) is selected in step S124, the background surface is switched to background surface 1.

### (Step S145)

The printing controller 111 waits to prepare for image formation during a switching time required for switching the reading mode. That is, the printing controller 111 delays the image formation timing during the switching time. The printing controller 111 delays the sheet feed timing of the sheet (next sheet) and delays the image formation start timing (writing timing) of the sheet 90.

In the following cases, the printing controller 111 may not exceptionally delay the image formation timing.
(1) (Switching time)<(Sheet interval time)

The sheet interval is set differently depending on the sheet size. For example, the sheet interval is shorter for A4, A3, and letter size sheets, and is longer for sheets of other sizes. Further, the sheet interval is much longer for sheet of irregular size (other than JIS standard). Therefore, in a case where the sheet interval time corresponding to the sheet size is longer than the switching time, the process (waiting) of step S145 is unnecessary.

(2) (Switching time)<(Time for changing sheet feed tray)

In a case where different sheet feed trays are used for the previous sheet and the next sheet, a delay time in which the sheet interval time between sheets before and after the change of the sheet feed tray becomes longer occurs due to the positional relationship of the sheet feed trays to be changed (sheet feed tray change time). A distance to a specific position (for example, an image formation position, the position of a registration roller, or the like) on the conveyance path varies depending on the sheet feed tray. For example, the following (2a) and (2b) are assumed.
(2a) A case where the previous sheet feed tray is switched to the next sheet feed tray after the absence of sheet (out of sheet) in the previous sheet is detected.
(2b) A case where the distance from the sheet feed tray after the switching is longer than that from the previous sheet feed tray (that is, a case where the sheet feed tray is switched to the sheet feed tray located further upstream). In this case, due to the switching of the sheet feed tray, the sheet interval between the last sheet from the sheet feed tray before the switching and the first sheet from the sheet feed tray after the switching becomes longer by an amount corresponding to the difference in the conveyance distance between the two sheet feed trays. That is, the sheet feed tray change time becomes longer.
(3) A case where the image stabilization processing is executed between the previous sheet and the next sheet. In this case, since the time required for the image stabilization processing is sufficiently longer than the switching time, the processing (waiting) in step S145 is unnecessary.

### (Step S150)

The printing controller 111 reads the print data of the designated page on the basis of the print setting, and transmits an instruction for preparing image formation for the next sheet 90 to the image former 13.

### (Step S160)

The printing controller 111 transmits, to the sheet feeder 25 of the sheet feed device 20 via the other-device controller 113, an instruction to start feeding the next sheet 90 from the sheet feed tray 255 designated in accordance with the print setting. The sheet feeder 25 feeds the sheet 90 from the designated sheet feed tray 255 and conveys the sheet 90 through the conveyance path 241. For example, in the example of sub job 1-2 of job 1 in FIG. 9B, the sheet 90 is fed from the tray 1.

### (Step S170)

The printing controller 111 determines whether or not the image position correction is enabled with reference to the print setting. The printing controller 111 advances the processing to step S220 when the image position correction is set as disabled, and advances the processing to step S180 when it is set as enabled. In the example of job 1 in FIG. 9A, the image position correction is set as “enabled”.

### (Step S180)

The printing controller 111 instructs the reading device 30 to read the sheet 90 before image formation through the reading device controller 112. The reader 50 reads the designated sheet 90 at the timing at which the sheet 90 is conveyed to the reading region of the conveyance path 341, and generates read data (image data).

### (Step S210)

The reading device controller 112 acquires the read data generated by the reading process in step S21 from the reading device 30 and temporarily stores the read data in the storage 12. Then, the reading device controller 112 gives the temporarily stored read data to the correction value calculator 114. The correction value calculator 114 recognizes the ends of the sheet 90 from the read data, and recognizes the lengths of the four sides or the shape of the sheet 90. In this case, during the reading process in step S180, the background surface disposed to face the reading sensor 51 (reading sensor) and serving as the background of the sheet 90 when the sheet 90 is read is set to a background surface of a color having high contrast with the sheet color of the sheet 90. Therefore, the correction value calculator 114 can accurately recognize the ends of the sheet 90 from the read data.

The correction value calculator 114 recognizes the sheet size from the recognized lengths of the four sides or shape, and calculates an image position correction value from the difference between the recognized sheet size and the sheet size in the print setting.

The correction value calculator 114 gives the calculated image position correction value to the printing controller 111 via the reading device controller 112. In job 1 illustrated in FIGS. 9A and 9B, the printing controller 111 uses the calculated image position correction value as a correction value for the image formation position on the back surface (second surface) to register the images on the front and back surfaces (first and second surfaces). The printing controller 111 gives the image formation position correction value to the image former 13 and sets the image formation position correction value.

### (Step S220)

The printing controller 111 transmits an image forming instruction for the next sheet 90 to the image former 13. The image former 13 forms an image on a sheet surface on the basis of the instructed print data. When this image is formed, the image position on at least one of the first surface and the second surface is finely adjusted on the basis of the image position correction value.

### (Step S230)

When there is a next page in the print job being executed as a result of checking the print setting, the printing controller 111 returns the processing to step S150 and repeats the subsequent processes. On the other hand, when the next page is not present, the printing controller 111 advances the processing to step S240.

### (Step S240)

When there is a next print job as a result of checking the print job reservation list, the printing controller 111 returns the processing to step S110 and repeats the subsequent processes. On the other hand, when the next print job is not present, the printing controller 111 ends the processing (END).

As described above, the image forming system according to the present embodiment includes a reader including a reading sensor that optically reads a sheet conveyed through a conveyance path, and the reader can execute a plurality of reading modes including at least a first reading mode and a second reading mode different from the first reading mode. The reader reads the sheet in any one of the reading modes selected according to a print setting, and the controller varies an image formation timing of forming an image on the sheet by the image former between when switching of the reading modes is performed and when the switching of the reading modes is not performed. With such a configuration, reading is performed at an appropriate timing, and thus it is possible to accurately detect the end position on the basis of the obtained read data and to accurately detect the sheet shape.

### Second Embodiment

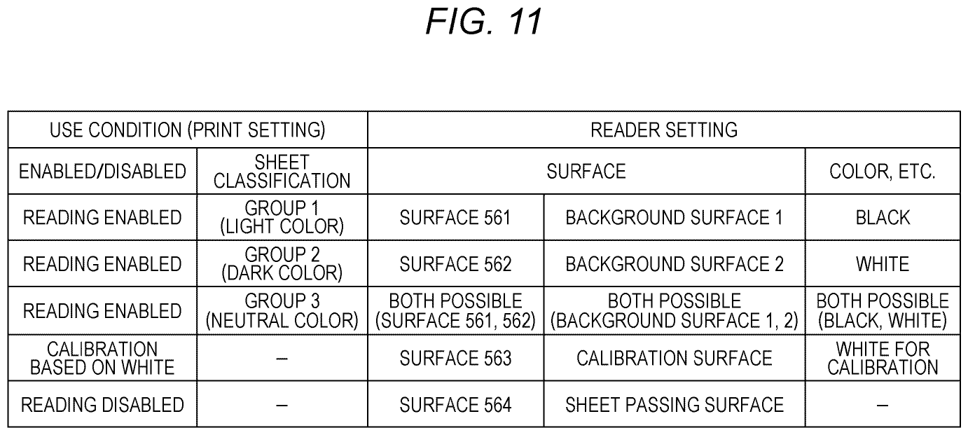

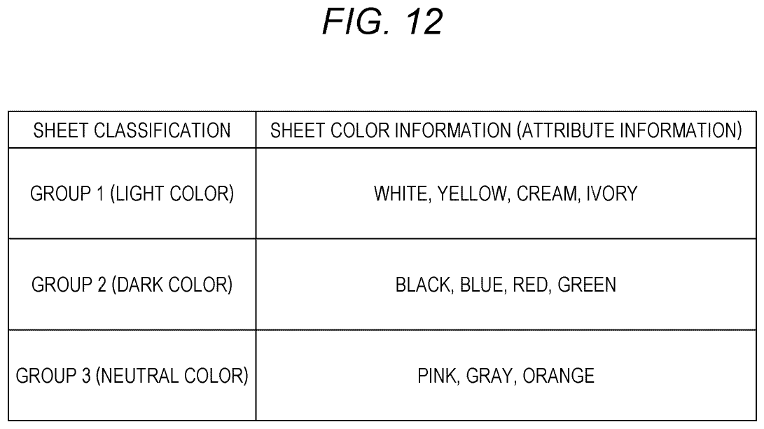

Next, an image forming system 1000 according to a second embodiment will be described with reference to FIGS. 11 to 13. FIGS. 11 and 12 are tables for describing use conditions of surfaces of a background section according to the second embodiment. In the first embodiment, the sheets are classified into two types, groups 1 and 2, according to the color of the sheets (see FIG. 6). In the second embodiment, the sheets are classified into three types including group 3 that is a neutral color as illustrated in FIG. 12. In addition, as illustrated in FIG. 11, a certain degree of contrast (brightness difference) can be ensured with respect to both of background surfaces 1 and 2 for the sheet of neutral color of group 3. Therefore, sufficient reading accuracy can be ensured in reading using either background surface 1 or 2.

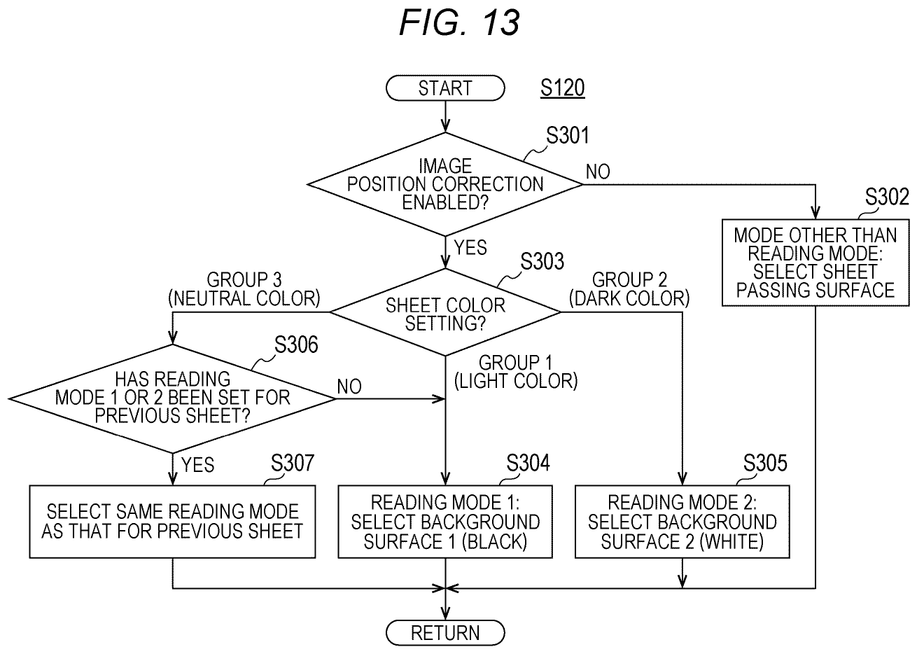

FIG. 13 is a subroutine flowchart illustrating processing of step S120 in FIG. 7 according to the second embodiment. The processes in FIG. 7 other than the processing illustrated in FIG. 13 are the same as those in the first embodiment, and thus, the description thereof will not be repeated.

### (Step S301)

The process of step S301 is the same as the process of step S121 in FIG. 8. The printing controller 111 determines whether or not the image position correction is enabled with reference to the print setting or the page setting, and then, advances the processing to step S303 when the image position correction is enabled, and advances the processing to step S302 when the image position correction is disabled.

### (Step S302)

The printing controller 111 selects a mode other than the reading mode. In this case, the sheet passing surface (surface 564) is selected.

### (Step S303)

The printing controller 111 acquires the sheet color (sheet information) in the print setting, and determines whether the sheet color belongs to group 1 (light color), group 2 (dark color), or group 3 (neutral color) with reference to the table in FIG. 11. The printing controller 111 advances the processing to step S304 when the sheet color belongs to group 1, advances the processing to step S305 when it belongs to group 2, and advances the processing to step S306 when it belongs to group 3.

### (Step S304)

The printing controller 111 selects reading mode 1. In this case, background surface 1 (black) (surface 561) is selected.

### (Step S305)

The printing controller 111 selects reading mode 2. In this case, background surface 2 (white) (surface 562) is selected.

### (Step S306)

The printing controller 111 determines whether the current sheet (i.e., the previous sheet) is in reading mode 1 or 2 and the background surface is currently set to background surface 1 or 2. The printing controller 111 advances the processing to step S307 when the previous sheet is in reading mode 1 or reading mode 2, and advances the processing to step S304 when the previous sheet is set to a mode other than the reading mode (i.e., sheet passing surface). In step S304, reading mode 1 (background surface 1) is selected. Note that the processing here may proceed to step S305. Regarding this selection, the printing controller 111 may select the one having a shorter switching time. For example, when the sheet passing surface is currently set, switching to background surface 1 provides a shorter switching time (smaller rotation angle (90 degrees)), and thus, reading mode 1 using background surface 1 is selected.

### (Step S307)

The printing controller 111 selects the same reading mode as the reading mode set for the previous sheet. That is, the reading mode is not changed from the reading mode for the previous sheet.

As described above, in the second embodiment, when the next sheet has sheet information indicating the third group (neutral color) and can be read in both the first reading mode and the second reading mode during continuous conveyance of sheets, the next sheet is read in the first reading mode same as that for the previous sheet. Thus, the reading mode is not switched between the previous sheet and the next sheet, whereby it is possible to prevent a change in image formation timing. Therefore, the productivity can be improved.

The main configurations of the reading device 30 and the image forming system 1000 including the reading device 30 have been described above for describing the features of the above embodiments, and the configurations of the reading device 30 and the image forming system 1000 including the reading device 30 described above are not limited to the abovementioned configurations, and can be modified in various manners within the scope of the claims. In addition, a configuration included in a general image forming apparatus is not excluded.

In addition, the descriptions with reference to FIG. 7 and the like indicate an example in which sheets having the same sheet color and sheet size are used in one print job, but the present invention is not limited thereto. For example, when colored sheets are mixed in one print job, the processes of step S120 and subsequent steps may be performed for each page or for each page in which colored sheet changes.

In addition, an example in which the color information regarding the color of the sheet is set by the user through the operation panel 18 or the like has been described, but the invention is not limited thereto. As another example, a detection sensor that detects a color or a density (brightness) may be disposed in the sheet feeder 25 or the conveyance paths 241 and 341 from the sheet feed tray 255 to the reader 50, and the controller 11 may select the background surface from a detection value of the detection sensor.

In addition, the means and method for performing various kinds of processing in the reading device 30 and the image forming system 1000 according to the above-described embodiments can be implemented by either a dedicated hardware circuit or a programmed computer. The program may be provided by, for example, a computer-readable recording medium such as a USB memory or a digital versatile disc (DVD)-ROM, or may be provided online via a network such as the Internet. In this case, the program recorded on the computer-readable recording medium is commonly transferred to and stored in a storage such as a hard disk. In addition, the program may be provided as independent application software or may be incorporated into software of an apparatus as one function of the apparatus.

While the embodiments of the present invention have been described and illustrated in detail, the disclosed embodiments have been created for purposes of illustration and example only, and not limitation. The scope of the present invention is to be interpreted by the wording of the appended claims.

What is claimed is:

1. An image forming system comprising:
a sheet feeder that feeds a sheet;
a conveyor that conveys the sheet through a conveyance path;
a reader including a reading sensor that optically reads the sheet conveyed through the conveyance path;
an image former that forms an image on the conveyed sheet at a downstream side of the reader in the conveyance path; and
a hardware processor, wherein
the reader is able to execute a plurality of reading modes including at least a first reading mode and a second reading mode different from the first reading mode, and reads the sheet in any one of the reading modes selected according to a print setting, and
the hardware processor varies an image formation timing of forming an image on the sheet by the image former between when switching of the reading modes is performed and when the switching of the reading modes is not performed.

2. The image forming system according to claim 1, wherein the reader executes a reading mode corresponding to a color of the sheet to be read among the reading modes.

3. The image forming system according to claim 1, wherein
the reader includes a background section that is disposed to face the reading sensor across the conveyance path, the background section having a plurality of background surfaces different in color and serving as a background of the sheet when the sheet is read, and
the switching of the reading modes is switching of the background surfaces.

4. The image forming system according to claim 3, wherein the reader switches the background surfaces according to a color of the sheet to be read.

5. The image forming system according to claim 1, wherein
the sheet feeder includes a plurality of sheet feed trays that stores sheets, and
a different reading mode is selected among the reading modes according to switching to the sheet feed tray from which a sheet to be read is fed.

6. The image forming system according to claim 1, wherein the hardware processor delays the image formation timing of forming an image by the image former on the sheet to be read in the second mode on the basis of a switching time required for switching from the first reading mode to the second reading mode.

7. The image forming system according to claim 6, wherein
the sheet feeder includes a plurality of sheet feed trays that stores sheets,
a different reading mode is selected among the reading modes according to switching to the sheet feed tray from which a sheet to be read is fed, and
the hardware processor compares a delay time of a timing of conveyance to a reading region of the reader due to a change of the sheet feed tray with a switching time required for switching the reading modes when a previous sheet and a next sheet are fed from different sheet feed trays while a plurality of sheets is consecutively conveyed, and does not delay the image formation timing of forming an image on the next sheet when the delay time is longer than the switching time.

8. The image forming system according to claim 6, wherein
a sheet interval between a previous sheet and a next sheet in a plurality of sheets that is consecutively convened is set differently according to a sheet size, and
the hardware processor compares a sheet interval time corresponding to the sheet interval with a switching time required for switching the reading modes, and does not delay the image formation timing of forming an image on the next sheet when the sheet interval time is longer than the switching time.

9. The image forming system according to claim 6, wherein,
when stabilization processing in the image former is executed between a previous sheet and a next sheet while a plurality of sheets is consecutively conveyed, the hardware processor does not execute processing of delaying the image formation timing of forming an image on the next sheet according to the switching of the reading modes, and switches the reading modes during a period in which the stabilization processing is executed.

10. The image forming system according to claim 1, wherein the hardware processor selects a reading mode to be executed among the reading modes on the basis of a print setting of a print job.

11. The image forming system according to claim 1, wherein, when a previous sheet is read in the first reading mode and a next sheet is readable in both the first reading mode and the second reading mode while a plurality of sheets is consecutively conveyed, the hardware processor executes reading of the next sheet in the first reading mode same as the reading mode for the previous sheet.

12. The image forming system according to claim 1, wherein, when a previous sheet is not to be read while a plurality of sheets is consecutively conveyed, the hardware processor starts switching the reading modes for the next sheet while the previous sheet is being conveyed through a reading region of the reader.

13. The image forming system according to claim 1, further comprising:
a correction value calculator that calculates a sheet position correction value on the basis of read data obtained by the reader reading the sheet; and
a printing hardware processor that adjusts a formation position of an image on at least one of a first surface or a second surface of the read sheet on the basis of the sheet position correction value calculated by the correction value calculator.

14. A printing method executed in an image forming system including
a sheet feeder that feeds a sheet,
a conveyor that conveys the sheet through a conveyance path,
a reader including a reading sensor that optically reads the sheet conveyed through the conveyance path, and
an image former that forms an image on the conveyed sheet at a downstream side of the reader in the conveyance path,
the reader being able to execute a plurality of reading modes including at least a first reading mode and a second reading mode different from the first reading mode, the printing method comprising:
a step (a) of selecting any one of the reading modes according to a print setting;
a step (b) of reading the sheet in the selected reading mode;
a step (c) of varying an image formation timing of forming an image on the sheet by the image former between when the reading modes are switched and when the reading modes are not switched; and
a step (d) of forming an image on the sheet at the image formation timing.

15. The printing method according to claim 14, wherein the step (a) includes selecting a reading mode corresponding to a color of the sheet to be read among the reading modes.
